(19) United States
(12) Patent Application Publication
(10) Pub. No.: US 2009/0190572 A1
(43) Pub. Date: Jul. 30, 2009

(54) DOWNLINK DATA CONTROL SYSTEM FOR RADIO ACCESS NETWORKS

(76) Inventor: Ilwoo Chang, San Diego, CA (US)

Correspondence Address: HARNESS, DICKEY & PIERCE P.L.C., 5445 CORPORATE DRIVE, SUITE 200, TROY, MI, 48098, US

(21) Appl. No.: 12/357,521

(22) Filed: Jan. 22, 2009

Related U.S. Application Data
(60) Provisional application No. 61/024,646, filed on Jan. 30, 2008.

(51) Int. Cl. H04J 3/06

(52) U.S. Cl. 370/350

(57) ABSTRACT

A service request device includes a transceiver that receives a downlink signal that includes at least one of an unreserved value, a resource status value, and a reserved value from a base station. The downlink signal is transmitted when a non-contention-based resource of the base station is not available for the service request device. A control module initiates a contention-based access procedure that synchronizes the service request device with the base station based on the at least one of the unreserved value, the resource status value, and the reserved value. The transceiver receives packets from the base station in response to the service request device being synchronized with the base station.

### CROSS-REFERENCE TO RELATED APPLICATIONS

This application claims the benefit of U.S. Provisional Application No. 61/024,646, filed on Jan. 30, 2008. The disclosure of the above application is incorporated herein by reference in its entirety.

### FIELD

The present disclosure relates to communication systems, and more particularly to protocols for managing access procedures based on arrival of downlink data.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In the standardization of evolved 3^{rd} Generation Partnership Project (3GPP™) networks, 3GPP™ system architecture evolution (SAE) work is defining a new architecture where both evolved 3GPP™ wireless access (LTE—Long Term Evolution access) and non-3GPP™ accesses are considered. The technical specification (TS) 23.401 “3GPP™ GPRS enhancements for LTE access” [1] and the TS 23.402” 3GPP™ Architecture enhancements for non-3GPP™ accesses” [2], which are incorporated herein by reference in their entirety, contain the current definitions for the architecture and related mechanisms. Specifically, [1] covers one possible implementation of the SAE network supporting LTE, and [2] describes an alternative that supports both LTE and non-3GPP™ accesses.

In a long-term evolution radio access network (LTE RAN), user data packets are transmitted and received between user equipment (UE) and base stations, such as evolved Node-B stations. The user data packets are transmitted and received using protocol stacks that are associated with the UE and the base stations. The protocol stacks each include three service and function layers L1, L2 and L3. The first layer (L1) is the bottom most layer and the third layer (L3) is the upper most layer. The L1 layer includes a physical (PHY) layer. The L2 layer includes a medium access (MAC) layer, a radio link control (RLC) layer, and a packet data convergence (PDCP) layer. The L3 layer includes a radio resource control (RRC) layer and may operate using an Internet protocol (IP).

In a radio access network, multiple UEs may communicate with a single base station. The base station may communicate with the UEs over a single traffic channel. The base station allocates traffic channel resources (e.g., time slots) to the UEs to prevent interference between signals from the UEs on the traffic channel. In order for a UE to receive and transmit packets via the base station, the UE transmits a request signal to the base station to use the traffic channel. This request includes a randomly selected preamble resource value.

For example, a preamble resource value may be 6 bits in length and have 1 of 64 possible values when none of the 64 values are reserved for non-contention-based communication and/or dedicated for other UEs. Non-contention-based communication refers to communication between a UE and a base station during a reserved resource that is dedicated to that particular UE. In one implementation, a preamble resource value is used to identify over-the-air traffic resources of a traffic channel. In one implementation, the traffic channel may support communication with up to 64 UEs and each preamble resource value may be associated with a particular time slot allocated by the base station. The base station responds to the UE with an acknowledgement (ACK) signal indicating to the UE that the base station has received the request signal. The ACK signal may include a timing adjustment value to synchronize with the base station. The UE may adjust timing based on the timing adjustment value. This synchronization allows the UE to transmit and/or receive signals to and from the base station within the allocated traffic channel resource(s) (e.g., time slot(s)).

Depending upon the packets being transmitted, packets associated with a UE may be generated in a “bursty” manner. In other words, “breaks” in packet transmission between the UE and a base station may occur. Over-the-air traffic resources may be allocated to the UE only when there is pending packets for transmission. When packets are not received for transmission for an extended period, the over-the-air traffic resources may be deallocated relative to the UE and time synchronization between the UE and the base station may be lost.

Also, distance between the base station and the UE may change resulting in a change in the length of time for a signal to travel between the UE and the base station. Due to this change in travel time, the UE may need to periodically adjust timing and/or re-establish synchronization with the base station. After time synchronization is lost, the UE must re-establish time synchronization with the base station before downlink and/or uplink packet transmission between the UE and the base station can resume.

### SUMMARY

The present disclosure describes methods, apparatus, and computer programs for synchronizing a service request device and a base station. In one implementation, the disclosure describes a service request device comprising a transceiver that receives a downlink signal that includes at least one of an unreserved value, a resource status value, and a reserved value from a base station, wherein the downlink signal is transmitted when a non-contention-based resource of the base station is not available for the service request device. The service request device further includes a control module that initiates a contention-based access procedure that synchronizes the service request device with the base station based on the at least one of the unreserved value, the resource status value, and the reserved value. The transceiver receives packets from the base station in response to the service request device being synchronized with the base station.

Implementations can include one or more of the following features. The non-contention-based resource may include a reserved preamble value that is associated with one of N traffic channel resources corresponding to permitted transmission of data to the base station, where N is an integer.

In other features, the transceiver receives a valid transmission period from the base station when receiving the reserved value. The valid transmission period is set to a predetermined value. The control module initiates the contention-based access procedure based on the valid transmission period.

In other features, the base station has X non-contention-based resources and Y contention-based resources, where X and Y are integers. The X non-contention-based resources are reserved for network devices other than the service request device.

In still other features, the unreserved value is a contention-based preamble value. The transceiver transmits a random preamble value associated with a contention-based access procedure based on the contention-based preamble value.

In other features, the resource status value indicates availability of a reserved preamble value of the base station. The transceiver transmits a random preamble value associated with a contention-based access procedure based on the resource status value.

In other features, the transceiver receives a timing adjustment signal from the base station based on the random preamble value. In other features, the reserved value is dedicated to a network device other than the service request device.

In yet other features, the base station receives the packets after time synchronization with the service request device is lost. The transceiver receives the downlink signal from the base station to resynchronize the service request device with the base station. In other features, the transceiver transmits a random access channel signal to the base station during the contention-based access procedure based on the downlink signal.

In still other features, the systems and methods described above can be implemented by a computer program executable by one or more programmable processors to perform functions by operating on input data and generating output. The computer program can reside on a computer readable medium such as but not limited to memory, nonvolatile data storage, and/or other suitable tangible storage mediums. Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF DRAWINGS

The present disclosure will become more fully understood from the detailed description and the accompanying drawings, wherein:

FIG. 1 is a message flow diagram illustrating a method of initiating contention-based and non-contention-based access procedures;

FIG. 2 is a functional block diagram of an exemplary network system in accordance with an embodiment of the present disclosure;

FIG. 3 is a functional block diagram of another exemplary network system in accordance with an embodiment of the present disclosure;

FIG. 4 is a functional block diagram of another exemplary network system in accordance with an embodiment of the present disclosure;

FIGS. 5A-C illustrate a method of initiating contention-based and non-contention-based access procedures in accordance with an embodiment of the present disclosure;

FIG. 6 is a message flow diagram illustrating a method of initiating contention-based and non-contention-based access procedures in accordance with an embodiment of the present disclosure;

FIG. 7 is another message flow diagram illustrating a method of initiating contention-based and non-contention-based access procedures in accordance with an embodiment of the present disclosure;

FIG. 8 is another message flow diagram illustrating a method of initiating contention-based and non-contention-based access procedures in accordance with an embodiment of the present disclosure;

FIG. 9A is a functional block diagram of a vehicle control system;

FIG. 9B is a functional block diagram of a cellular phone; and

FIG. 9C is a functional block diagram of a mobile device.

### DESCRIPTION

In a radio access network, user equipment (UE) may establish a communication link with a base station in order to receive packets from the base station. To receive the packets the UE and the base station are synchronized. An uplink synchronization timer may be maintained. When packets are not transmitted for an extended period, synchronization between the UE and the base station may be lost. Accordingly if synchronization is lost, the UE must be resynchronized with the base station in order to again receive new packets from the base station.

In order to reestablish synchronization between a UE and a base station, various procedures may be followed. As an example, time synchronization may be reestablished using a random access channel (RACH) procedure. Examples of RACH procedures are described in detail below.

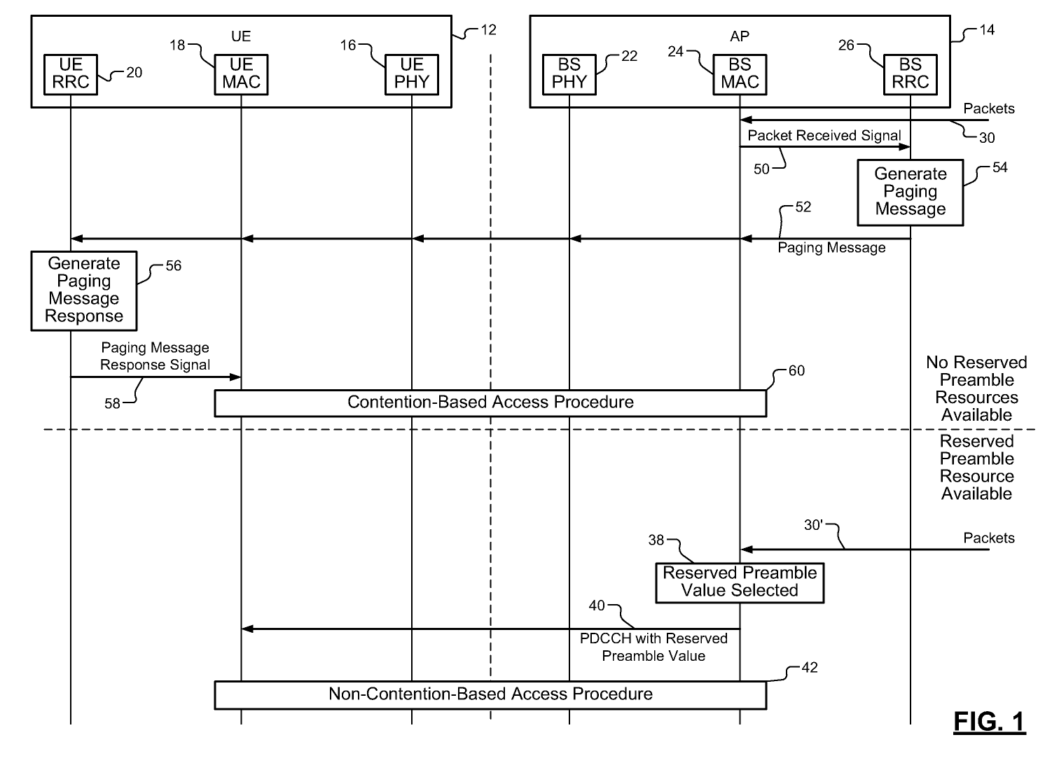

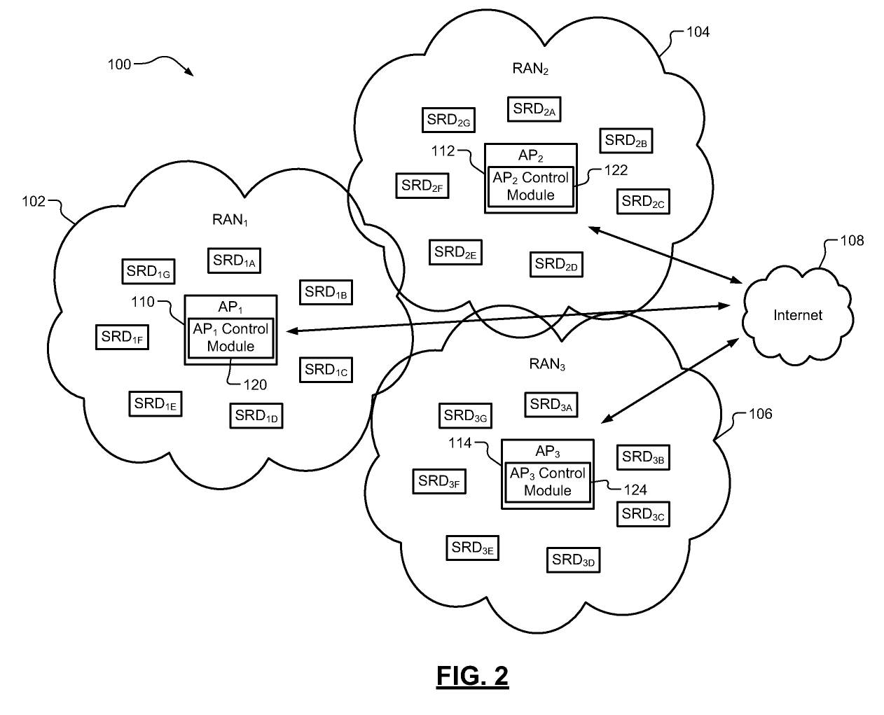

FIG. 1 depicts a message (signal) flow diagram of a method for initiating contention-based and non-contention-based access procedures in a radio access network. The radio access network includes a UE 12 and a base station 14. As illustrated, the UE 12 includes a physical (PHY) layer 16, a medium access control (MAC) layer 18, and a radio resource control (RRC) layer 20. The base station 14 includes a PHY layer 22, a MAC layer 24, and a RRC layer 26. A MAC protocol specification is described in the 3GPP™ TS 36.321 “Evolved Universal Terrestrial Radio Access (E_UTRA) Medium Access Control (MAC) protocol specification”, which is incorporated herein by reference in its entirety.

After time synchronization is lost between the UE 12 and the base station 14 new downlink packets for the UE 12 may be received by the base station 14. This is shown by packet signals 30, which are received by the MAC layer 24. Upon reception of the packets and before indication to the UE 12 that new packets have been received, the MAC layer 24 may determine whether a reserved preamble resource of the base station 14 is available.

A reserved preamble resource refers to a value that is associated with a time slot for dedicated transmission by a UE to a base station. A base station may, for example, have N preamble resources (over-the-air traffic resources) available. M of the N resources may be reserved preamble resources, which may be dedicated to assigned UEs. N and M are integers and N is greater than M. N minus M of the preamble resources may be referred to as random preamble resources, which may be used by UEs that are establishing a communication link with the base station for a first time. The random preamble resources are associated with contention-based communication since more than one UE may select and use the same resource value during the same period. The base station may assign (dedicate) a reserved preamble resource to a UE.

When more than one reserved preamble resource is available, the MAC layer 24 may select one of the reserved preamble resources for the UE, designated by box 38. When a reserved preamble resource is available, the base station 14 may transmit a physical downlink control channel (PDCCH) signal to assign a reserved preamble resource to the UE 12, designated by PDCCH signal 40. The base station 14 may provide the value of the reserved preamble resource to the UE 12 when transmitting the PDCCH signal 40. The PDCCH signal 40 may include a UE identifier (ID), such as a cell radio network temporary identifier (CRNTI) (short form ID). A CRNTI may, for example, include 16 bits.

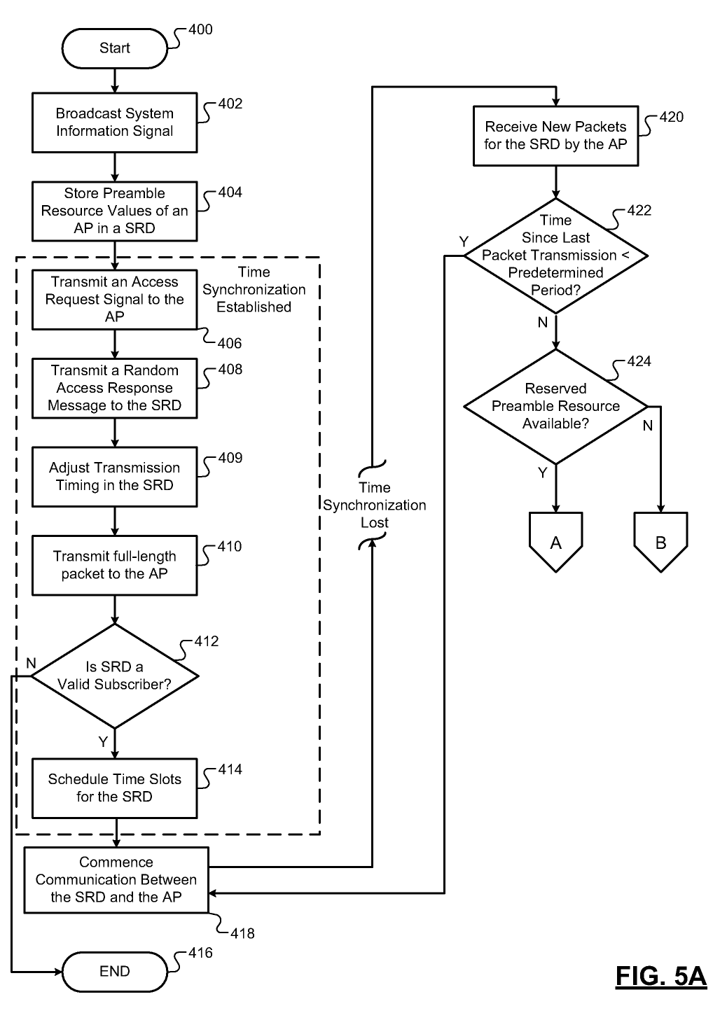

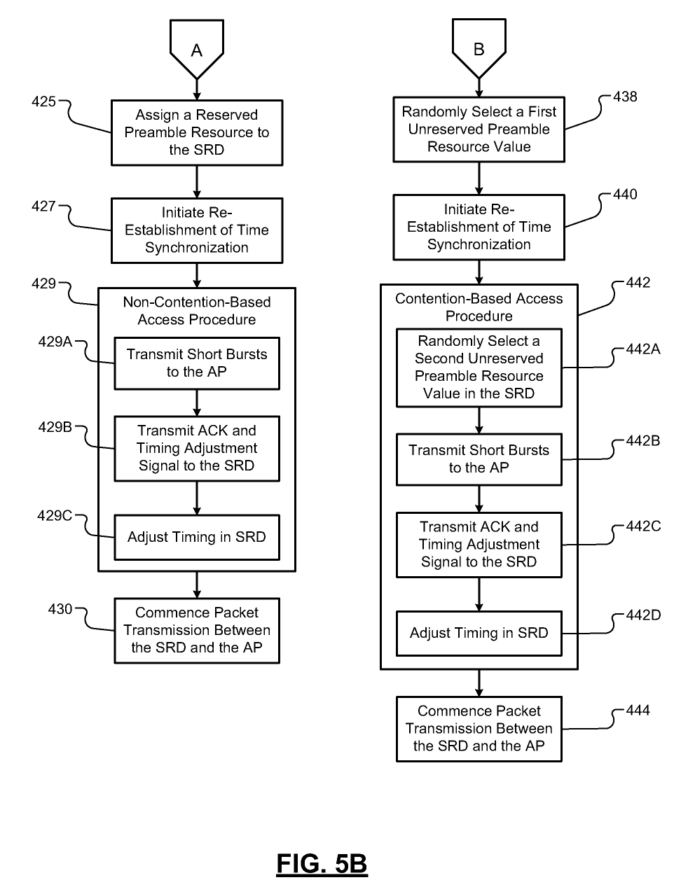

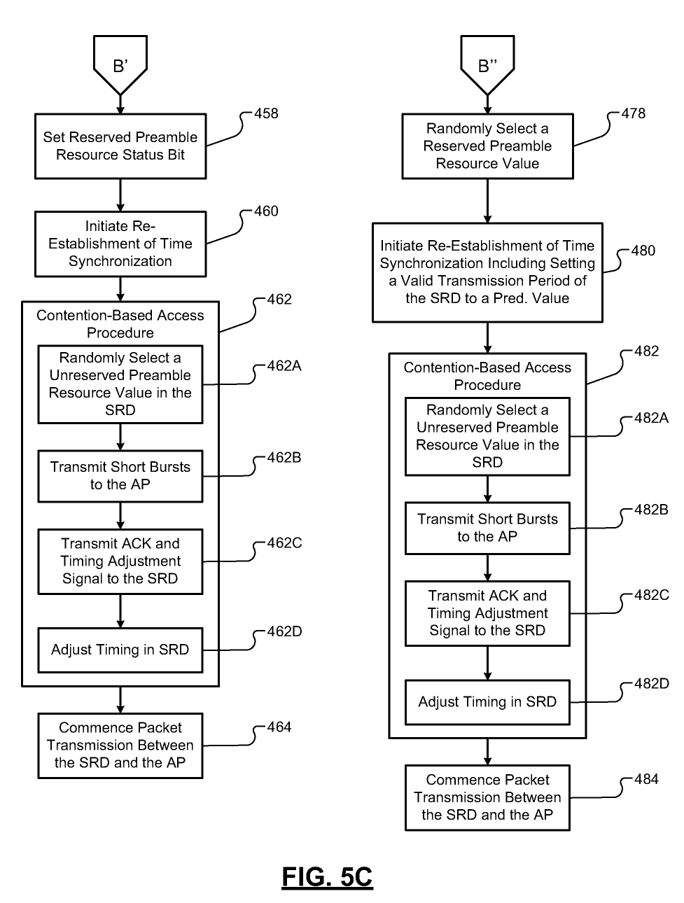

As the UE 12 is assigned a dedicated preamble resource, there is not interference between signals transmitted by the UE 12 and signals transmitted by other UEs to the base station 14. As a result, the UE 12 may trigger (initiate) a non-contention-based RACH procedure, as designated by box 42. The non-contention-based RACH procedure synchronizes the UE 12 with the base station 14 via communication between the MAC layers 18, 24. An example of a non-contention-based RACH procedure is described below with respect to the embodiment of FIG. 5.

When a reserved preamble resource is not available, the MAC layer 24 generates a packet received signal 50, which is transmitted to the RRC layer 26 of the base station 14. A reserved preamble resource may not be available, for example, in a high traffic or busy area where many UEs are in communication with the base station. The RRC layer 26 generates a paging message 52, designated by box 54. The paging message 52 is transmitted to the UE 12. The paging message 52 may include a UE identifier (ID), such as an international mobile subscriber ID (IMSI) (long form ID), a reason for RRC paging message transmission, etc. The IMSI may, for example, include 8-9 bytes that represent 15-16 digits (international phone number).

The RRC layer 20 may generate a paging message response signal 58 based on the paging message 52, designated by box 56. The paging message response signal 58 is transmitted to the MAC layer 18, which then initiates a contention-based RACH procedure, designated by box 60. The contention-based RACH procedure is used due to the possibility of more than one UE transmitting signals to the base station during the same period. An example of a contention based RACH procedure is described below.

The generating, transmitting and processing of the packet received signal 50, the paging message 52, and the paging message response signal 58 consumes time. More efficient techniques are described below for situations when a reserved preamble resource is not available.

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

In the following description, a service request device (SRD) may refer to user equipment (UE) and/or a mobile node. A service request device may include equipment of an end user, such as a processor, a radio interface adaptor, etc. A service request device may include a mobile network device, a personal data assistant (PDA), a computer, etc.

Also, in the following description various networks and network devices are disclosed. A network device may refer to a UE, a base station, a service request device, an access point (AP), etc. A network device may refer to a control module, a transceiver, a protocol stack of a transceiver or a communication layer, such as a PHY layer, a MAC layer, a radio link control (RLC) layer, a packet data convergence protocol (PDCP) layer, a RRC layer, etc. Although a particular number of each network device is shown, any number of each network device may be included. Each of the network devices may be considered a remote network device relative to another network device.

In addition, in the following description various variable labels are disclosed. The variable labels are provided as examples only. The variable labels are arbitrarily provided and may each be used to identify or refer to different items. For example, the variable label N may be used to refer to an integer value when identifying a number of preamble resources or as an integer value when identifying a number of time slots.

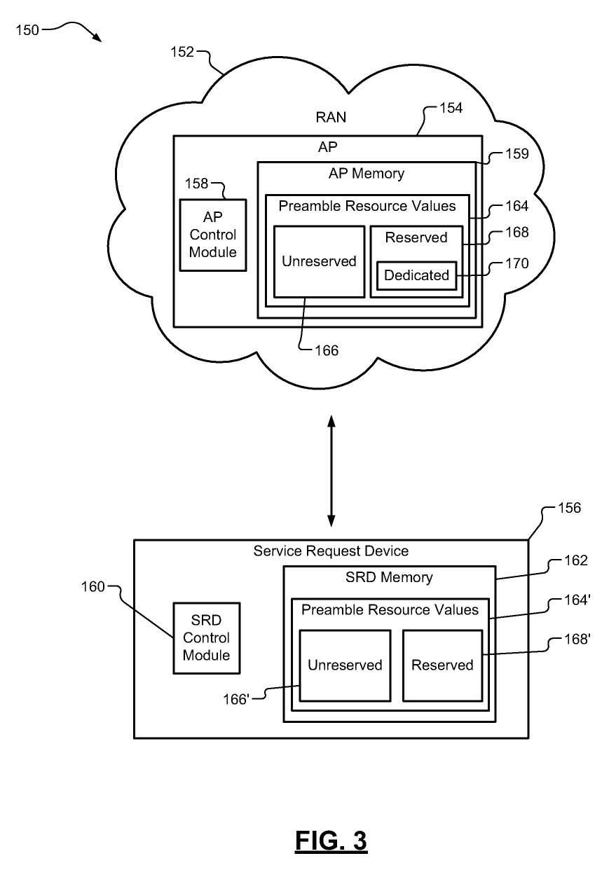

FIG. 2 illustrates a functional block diagram of an exemplary network system 100. The network system 100 includes radio access networks (RANs) 102-106 that are in communication with an Internet 108. The RANs 102-106 may respectively have APs 110-114 that are in communication with service request devices. In the example embodiment, SRDs_{1A-1G} are located in the RAN 102, SRDs_{2A-2G} are located in the RAN 104, and SRDs_{3A-3G} are located in the RAN 106. The SRDs_{1A-1G}, the SRDs_{2A-2G}, and the SRDs_{3A-3G} are in respective communication with the APs 110-114. The APs 110-114 have respective control modules 120-124.

The SRDs_{1A-1G}, the SRDs_{2A-2G}, and the SRDs_{3A-3G} may request various real-time and non-real-time services, such as Web browsing, voice over Internet phone (VoIP), electronic mail (email), file transfer protocol (ftp) applications, and real-time IP multimedia, as well as conversational and streaming services. The real-time and non-real-time services may be provided by the RANs 102-106.

The APs 110-114, for example, may be base stations, such as evolved node B base stations (eNodeBs). The APs 110-114 may include one or more home agents, such as routers. The APs 110-114 may comply with one or more IEEE standards, such as 802.11, 802.11a, 802.11b, 802.11g, 802.11h, 802.11n, 802.16, and 802.20, which are incorporated herein by reference in their entirety.

The RANs 102-106 may be cellular networks, LTE RANs, or other wireless access networks, some of which are disclosed below. The RANs 102-106 may include 3GPP™ system networks, a visited public land mobile network (VPLMN), a home PLMN (HPLMN), etc. The RANs 102-106 may comply with [1], [2], TS 22.278” 3GPP™ Service requirements for the evolved packet system (EPS)”, TS 23.060 “General Packet Radio Service (GPRS) service description”, which are incorporated herein by reference in their entirety.

In operation, the control modules 120-124 assign one or more traffic channel resources (e.g., time slots)) to the SRDs_{1A-1G}, the SRDs_{2A-2G}, and the SRDs_{3A-3G}. Thus, for example, the SRDs_{1A-1G}, the SRDs_{2A-2G}, and the SRDs_{3A-3G} may communicate with the control modules 120-124 during the provided time slots synchronize with the control modules 120-124. The control modules 120-124 may use contention-based and non-contention-based techniques described herein to re-establish synchronization with the SRDs_{1A-1G}, the SRDs_{2A-2G}, and the SRDs_{3A-3G}. Resynchronization may be performed, for example, when synchronization is lost and new pending packets for transmission to the SRDs_{1A-1G}, the SRDs_{2A-2G}, and the SRDs_{3A-3G} are received by the APs 110-114.

FIG. 3 illustrates a functional block diagram of another exemplary network system 150. The network system 150 includes a RAN 152, an AP 154, and a SRD 156. The AP 154 includes an AP control module 158 and AP memory 159. The SRD 156 includes a SRD control module 160 and SRD memory 162.

The memories 159, 162 store respectively preamble resource values 164, 164′ including unreserved preamble values 166, 166′ (contention-based) and reserved preamble values 168, 168′ (non-contention-based). The reserved preamble values 168 may include dedicated preamble values 170. For example, the AP memory 159 may store N preamble resource values with M reserved values and P unreserved values. The M reserved values may include Q dedicated values. N, M, P, and Q may be integers, where N is greater than M, N is greater than P, and M is greater than or equal to Q. For example only, N may be 64, M may be 16, and P may be 48. The N preamble resource values may be 0-63, the M reserved values may be 0-15, and the P unreserved values may be 16-63. The bit length associated with identification of the preamble resource values for the provided example is 6 bits.

The AP control module 158 assigns a time slot in which the SRD 156 may communicate and synchronize with the AP 154. The control modules 158, 160 may use contention-based and/or non-contention-based techniques described herein to re-establish synchronization with each other. During the contention-based techniques the AP control module 158 may assign one of the reserved preamble values or one of the unreserved preamble values to the SRD 156. During the contention-based based techniques the SRD 156 may use the provided unreserved preamble value or another unreserved preamble value when synchronizing with the AP 154. The SRD 156 does not use the reserved preamble value for synchronization during the contention-based techniques.

The SRD memory 156 may store preamble resource values provided by the AP 154. The preamble resource values 164′ stored by the SRD memory 162 may match the preamble resource values 164 stored in the AP memory 159. The SRD 156 may select one of the unreserved values 166′ when communicating over contention-based time slots.

During the non-contention-based techniques the AP control module 158 may assign one of the reserved preamble resource values to the SRD 156. During the non-contention-based techniques the SRD 156 may use the assigned reserved preamble resource value and may not use one of the unreserved preamble resource values when synchronizing with the AP 154.

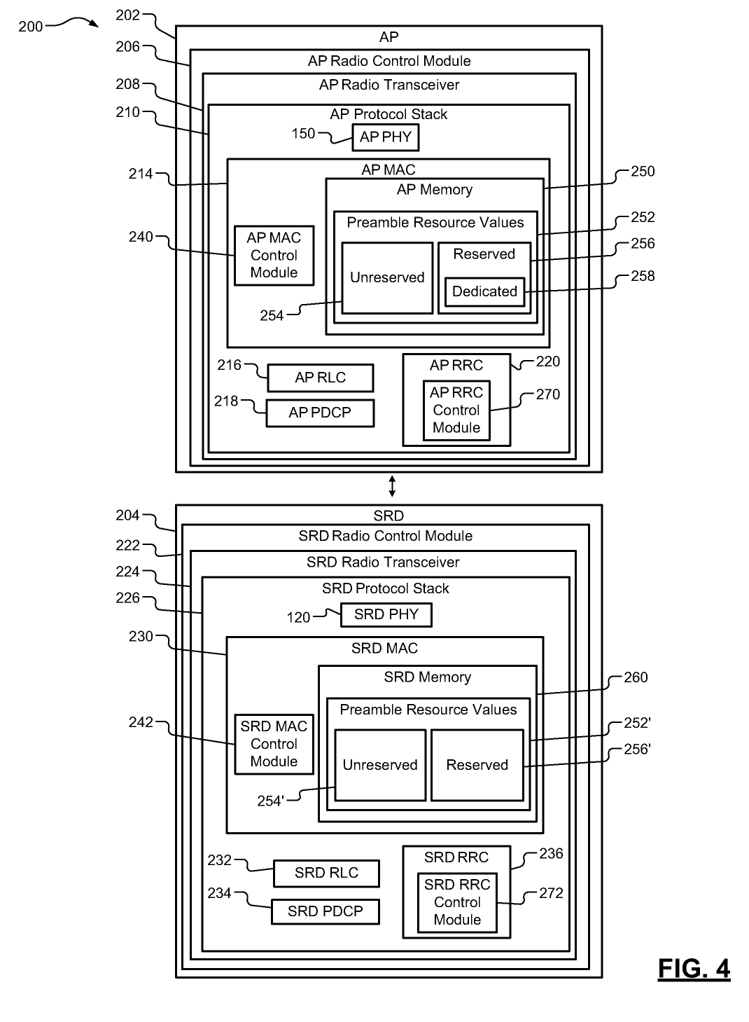

FIG. 4 illustrates a functional block diagram of another exemplary network system 200. The network system 200 includes an AP 202 and a SRD 204 that are in wireless communication with each other. The AP 202 includes an AP radio control module 206 with an AP radio transceiver 208 that has an AP protocol stack 210, such as an AP LTE protocol stack. The AP protocol stack 210 may include an AP PHY layer 212, an AP MAC sub-layer 214, an AP RLC sub-layer 216, an AP PDCP sub-layer 218 and an AP RRC sub-layer 220. The SRD 204 includes a SRD radio control module 222 with a SRD radio transceiver 224 that has a SRD protocol stack 226, such as a SRD LTE protocol stack. The transceivers 208, 224 wirelessly communicate with each other. The SRD protocol stack 226 may include an SRD PHY layer 228, an SRD MAC sub-layer 230, an SRD RLC sub-layer 232, an SRD PDCP sub-layer 234 and an SRD RRC sub-layer 236.

The PHY layers 218, 228 may be referred to as L1 layers. The MAC, RLC and PDCP sub-layers 214, 230, 216, 232, 218, 234 are associated with data link layers (L2). The RRC sub-layers 220, 236 are associated with network layers (L3). In general, the RRC sub-layers 220, 236 are considered upper layers to the PDCP sub-layers 218, 234, which are considered upper layers to the RLC sub-layers 220, 236. The RLC sub-layers 220, 236 are considered upper layers to the MAC sub-layers 214, 230. The MAC sub-layers 214, 230 are considered upper layers to the PHY layers 212, 228. The functions of the above layers may include functions described in, for example, the Radio Interface Protocol Architecture 3GPP TS 25.301 or in the 3GPP™ TS 36.321, which are incorporated herein by reference in their entirety.

The PHY layers 212, 228 provide information transfer services to the MAC sub-layers 214, 230 and other upper layers. The PHY layers 212, 228 provide macrodiversity distribution and combining and soft handover execution, error detection, encoding/decoding, multiplexing, frequency and time synchronization, RF processing, etc.

The MAC sub-layers 214, 230 include respective control modules 240, 242 and provide data transfer including unacknowledged transfer of MAC service data units (SDUs). The MAC sub-layers 214, 230 also provide reallocation of radio resources, changes of MAC parameters, mapping between logical channels and transport channels, selection of transport formats, priority handling, etc. The AP MAC sub-layer 214 provides preamble resource values to the SRD MAC sub-layer 230. The SRD MAC sub-layer 230 initiates contention and non-contention-based time synchronization techniques.

The AP 202 and/or the AP MAC sub-layer 214 may have AP memory 250 or have access to memory that stores preamble resource values 252 including unreserved, reserved, and dedicated resource values 254, 256, 258. The SRD 204 and/or the SRD MAC sub-layer 230 may have SRD memory 260 or have access to memory that stores preamble resource values 252′ including unreserved and reserved resource values 254′, 256′. The preamble resource values 252′ stored in the SRD memory 260 or accessed by the SRD 204 may be values broadcast by the AP 202.

The RLC sub-layers 216, 232 provide automatic repeat request (ARQ) functionality coupled with radio transmission. The RLC sub-layers 216, 232 at transmitting sides retransmit failed packets based on ARQ positive ACK signal or negative ACK (NACK) feedback signal from the RLC sub-layers 216, 232 at receiving sides. The RLC sub-layers 216, 232 have multiple operating modes including a transparent mode (TM), an unacknowledged mode (UM), and an acknowledged mode (AM). The RLC sub-layers 216, 232 provide transparent data transfer of upper layer packet data units (PDUs), unacknowledged data transfer of upper layer PDUs, and acknowledged data transfer of upper layer PDUs. The RLC sub-layers 216, 232 provide segmentation and reassembly, concatenation, transfer of user data, flow control, sequence number checking, SDU discarding, etc.

The PDCP sub-layers 218, 234 provide PDCP SDU delivery. The PDCP sub-layers may provide header compression and decompression, transfer of user data, PDCP SDU discard, etc. PDCP SDU discard is used to discharge a PDCP SDU from a buffer.

The RRC sub-layers 220, 236 include respective control modules 270, 272 and handle control plane signaling of the L3 layers between the SRD 204 and the RAN 200. The AP RRC sub-layer 220 is used to broadcast information to SRDs. The broadcast information may include system information, which may be iteratively broadcast on a regular basis. The system information may include preamble resource values including the number of unreserved and reserved resource values and corresponding identification of each preamble resource value. The AP RRC sub-layer 220 may perform scheduling and segmentation, as well as establishment, re-establishment, and maintenance of a RRC connection between the SRD 204 and the RAN 200.

The establishment of an RRC connection includes an optional cell re-selection, an admission control, and a L2 layer signaling link establishment. The release of an RRC connection can be initiated by a request from higher layers to release the last signaling connection for the SRD 204 or by the AP RRC sub-layer 220 in case of RRC connection failure. In case of connection loss, the SRD 204 may request re-establishment of the RRC connection. In case of RRC connection failure, the AP RRC sub-layer 220 releases resources associated with the RRC connection. The AP RRC sub-layer 220 may assign, reconfigure and release radio resources (e.g. codes) for an RRC connection. The SRD RRC sub-layer 236 may perform measurement reporting, see 3GPP TS 25.301, which is incorporated by reference herein in its entirety.

FIGS. 5A-C illustrate a method of initiating contention-based and non-contention-based access procedures. The method may begin at step 400.

In step 402, an AP broadcasts a system information signal that includes information regarding the number and identity of preamble resource values including unreserved and reserved preamble resource values. In step 404, the SRD receives the system information signal and stores the preamble resource values.

In step 406, a SRD transmits an access request signal (e.g., a traffic channel request signal) to the AP to request establishment of a communication link between the AP and the SRD to be provided with a service. The access request signal may include an unreserved preamble resource value, which may be randomly selected from the stored unreserved preamble resource values of step 404.

During this step the SRD may not have information regarding distance between the AP and the SRD. For this reason and to avoid interference with packets transmitted by other APs during current, preceding, and/or subsequent time slots, the traffic channel request signal may be transmitted in short bursts. The longer the packets that are transmitted for a given distance between the AP and the SRD, the greater the chance of interference with packets transmitted in different time slots.

In step 408, the AP transmits a random access response message to the SRD. The random access response message includes an acknowledgement of reception of the access request signal. The random access response message also may include a timing adjustment message. The timing adjustment message may include a timing adjustment value, which may be used by the SRD to adjust when packets are sent to the AP. The random access response message may further include a stop sending short burst request.

In step 409, the SRD adjusts transmission timing based on the random access response message. In step 410, the SRD may transmit a full-length packet to the AP. The full-length packet may include, for example, an international mobile subscriber (IMSI) ID.

In step 412, the AP determines whether the SRD is a valid subscriber based on the full-length packet. In step 414, when the SRD is a valid subscriber, the AP schedules traffic channel resource(s) for the SRD. In step 416, when the SRD is not a valid subscriber, control associated with establishing a communication link with the SRD may end.

In step 418, communication between the SRD and the AP commences using a short form SRD ID, such as a cellular radio network temporary identifier (CRNTI), and based on the time synchronization of steps 408 and 409. The CRNTI is a short form SRD ID. The short form SRD ID may be used instead of the IMSI to identify the SRD. The short form SRD ID may be used instead of a long form SRD ID when transmitting packets from the AP to the SRD or when transmitting packets from the SRD to the AP.

After step 418, packet transmission between the SRD and the AP may cease for an extended period. As a result, the time synchronization established between the SRD and the AP in steps 408-409 may be lost. During the extended period of time the SRD may have moved and may currently be closer to or farther away from the AP.

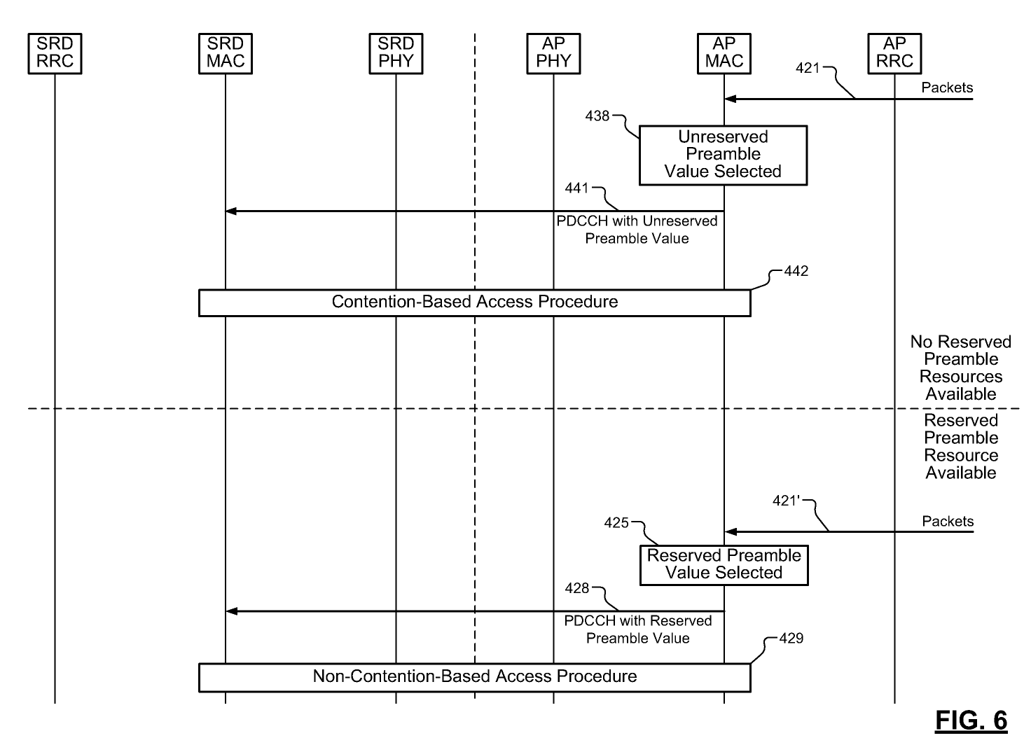

In step 420, the AP receives new packets 421 that are to be transmitted to the SRD. The packets 421 are shown in FIGS. 6-8. Packets received when no reserved preamble resources are available are designated as packet signal 421, packets that are received when preamble resources are available are designated packet signal 421′. The new packets 421 may be received, for example, by a MAC sub-layer of the AP from other layers of the AP.

In step 422, the AP and/or MAC sub-layer may determine time lapsed from a last previously transmitted packet to reception of the newly received packet. When the time lapsed is less than a predetermined period, the AP and/or MAC sub-layer may return to step 418 and may transmit the newly received packets to the SRD, otherwise the AP and/or MAC sub-layer may proceed to step 424.

In step 424, the AP determines if there is one or more reserved preamble resource values available. When a reserved preamble resource value is available, the AP proceeds to step 425, otherwise the AP proceeds to step 438.

Referring now also to FIGS. 6-8, message flow diagrams illustrating contention and non-contention-based access procedures are shown. The non-contention-based access procedures of FIGS. 6-8 are similar and are described in steps 426-430.

In step 425, the AP and/or MAC sub-layer of the AP may select and assign a reserved preamble resource value to the SRD. The reserved preamble resource value is dedicated to the SRD.

In step 427, the AP initiates re-establishment of time synchronization with the SRD. The AP may transmit a packet downlink control channel (PDCCH) signal 428 with the selected reserved preamble resource value and the short form SRD ID to the SRD. In transmitting the PDCCH signal to the SRD, the AP is requesting time synchronization with the SRD.

In step 429, the SRD may perform a non-contention-based access procedure, such as a non-contention-based RACH procedure, using the dedicated reserved preamble resource value.

In step 429A, the SRD transmits short bursts that include the dedicated reserved preamble resource value to the AP. In step 429B, the AP receives the short bursts and transmits an acknowledgement signal and/or timing adjustment signal to the SRD. The acknowledgement and timing adjustment signals may include the short form SRD ID and the newly received packets.

In step 429C, the SRD adjusts timing, such as when packets are transmitted by the SRD based on the timing adjustment signal of step 429B. Time synchronization between the SRD and the AP is re-established. This accounts for changes in distance between the SRD and the AP. In step 430, packet transmission between the SRD and the AP commences based on the time synchronization of steps 429B and 429C.

Referring now to FIGS. 5B and 6 for a description of a contention-based access procedure. In step 438, the AP may randomly select a first unreserved preamble resource value.

In step 440, the AP initiates re-establishment of time synchronization with the SRD. The AP may transmit a PDCCH signal 441 with an unreserved preamble resource value and the short form SRD ID to the SRD. When the reserved preamble resource values are dedicated to network devices other than the SRD, the AP may transmit one of the unreserved preamble resource values. In transmitting the PDCCH signal to the SRD, the AP is requesting time synchronization with the SRD.

In step 442, the SRD performs a contention-based access procedure, such as a contention-based RACH procedure based on the PDCCH signal of step 440. The SRD determines that a contention-based access procedure should be performed by receiving an unreserved preamble resource value, which is out of a range of preamble resource values associated with a non-contention-based access procedure. For example, the AP may have preamble resource values 0-63, where values 0-15 are reserve preamble resource values and values 16-63 are unreserved preamble resource values. The AP may assign the value 45 to the SRD. The SRD is able to determine that the value 45 is an unreserved preamble resource value based on the broadcast of step 402.

In step 442A, the SRD randomly selects a second unreserved preamble resource value. The second unreserved preamble resource value may be the same as or different than the first unreserved preamble resource value. The selection of another unreserved preamble resource value provides an additional level of random selection. The selection of a different unreserved preamble resource value prevents collision/interference between packets transmitted by multiple SRDs. In step 442B, the SRD transmits short bursts that include the second unreserved preamble resource value to the AP.

In step 442C, the AP receives the short bursts and transmits an acknowledgement signal and/or timing adjustment signal to the SRD. The acknowledgement and timing adjustment signals may include the short form SRD ID and the newly received packets.

In step 442D, the SRD adjusts timing, such as when packets are transmitted by the SRD based on the timing adjustment signal of step 442C. Time synchronization between the SRD and the AP is reestablished. In step 444, packet transmission between the SRD and the AP commences based on the time synchronization of steps 442C and 442D.

Referring now to FIGS. 5C and 7 for a description of another contention-based access procedure. Steps 458-464 may be performed alternatively to steps 438-444.

In step 458, the AP and/or MAC sub-layer of the AP may set reserved preamble resource status bit of a PDCCH signal 459. When the reserved preamble resource values are dedicated to network devices other than the SRD, the AP may set a reserved preamble resource status bit of the PDCCH signal 459 to indicate that the reserved preamble resource values are used. The reserved preamble resource status bit, for example, may be set to “1” when the reserved preamble resource values are used and to “0” when one of the reserved preamble resource values is available.

In step 460, the AP initiates re-establishment of time synchronization with the SRD. The AP may transmit the PDCCH signal 459 with the reserved preamble resource status and the short form SRD ID to the SRD. One or more reserved preamble resource status bits, such as the reserved preamble resource status bit may be included in the PDCCH signal 459. The reserved preamble resource status bits may indicate the number of available reserved preamble resource values. In transmitting the PDCCH signal 459 to the SRD, the AP is requesting time synchronization with the SRD.

In step 462, the SRD performs a contention-based access procedure, such as a contention-based RACH procedure based on the PDCCH signal of step 460. In step 462A, the SRD randomly selects an unreserved preamble resource value. In step 462B, the SRD transmits short bursts that include the unreserved preamble resource value of step 462A to the AP.

In step 462C, the AP receives the short bursts and transmits an acknowledgement signal and/or timing adjustment signal to the SRD. The acknowledgement and timing adjustment signals may include the short form SRD ID.

In step 462D, the SRD adjusts timing, such as when packets are transmitted by the SRD based on the timing adjustment signal of step 462C. Time synchronization between the SRD and the AP is reestablished. In step 464, packet transmission between the SRD and the AP commences based on the time synchronization of steps 462C and 462D.

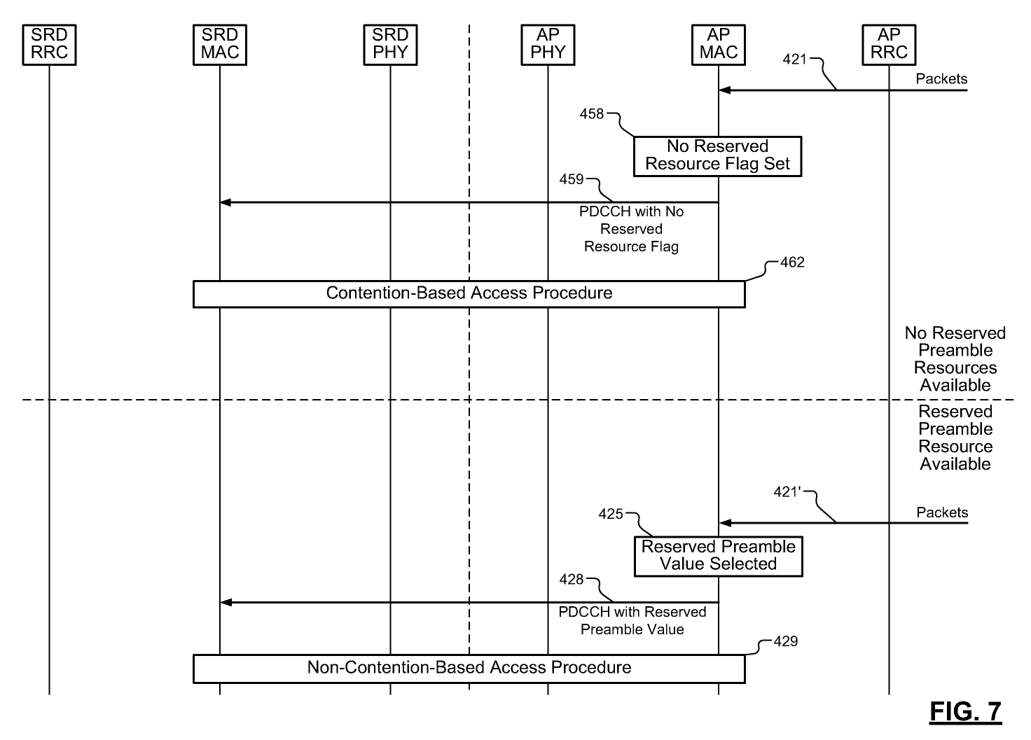

Referring now to FIGS. 5C and 8 for a description of a contention-based access procedure. Steps 478-484 may be performed alternatively to steps 438-444. In step 478, the AP may select a reserved preamble resource value.

In step 480, the AP initiates re-establishment of time synchronization with the SRD. The AP may transmit a PDCCH signal 481 with a reserved preamble resource value and the short form SRD ID to the SRD. When the reserved preamble resource values are dedicated to network devices other than the SRD, the AP may transmit one of the reserved preamble resource values. A valid transmission period is set to an invalid or predetermined value (e.g., zero). The PDCCH signal 481 includes the valid transmission period. The combination of transmitting a reserved preamble resource value along with a valid transmission period of zero indicates to the SRD that reserved preamble resource values are used and that a contention-based access procedure should be performed. In transmitting the PDCCH signal 481 to the SRD, the AP is requesting time synchronization with the SRD.

In step 482, the SRD performs a contention-based access procedure, such as a contention-based RACH procedure based on the PDCCH signal of step 480. In step 482A, the SRD randomly selects an unreserved preamble resource value. In step 482B, the SRD transmits short bursts that include the unreserved preamble resource value to the AP.

In step 482C, the AP receives the short bursts and transmits an acknowledgement signal and/or timing adjustment signal to the SRD. The acknowledgement and timing adjustment signals may include the short form SRD ID and the newly received packets.

In step 482D, the SRD adjusts timing, such as when packets are transmitted by the SRD based on the timing adjustment signal of step 482C. Time synchronization between the SRD and the AP is reestablished.

In step 484, packet transmission between the SRD and the AP commences based on the time synchronization of steps 482C and 482D.

The above-described steps in the above-described Figures are meant to be illustrative examples; the steps may be performed sequentially, synchronously, simultaneously, continuously, during overlapping time periods or in a different order depending upon the application.

The embodiments disclosed herein provide efficient methods of signaling downlink data arrival by a base station or access point to a SRD. The embodiments provide efficient methods of triggering timing resynchronization between the access point and the SRD. The efficient signaling and triggering methods include signaling and triggering when reserved preamble resources of a base station are not available.

The embodiments enclosed herein also provide consistency between situations when a preamble resource is available and when a preamble resource is not available. When a RRC paging message is transmitted, such as when using the technique described with respect to FIG. 1, there is dependency and interaction between RRC and MAC sub-layers of protocol stacks. This dependency and interaction is reduced when using the techniques described with respect to the embodiments of FIGS. 5-8.

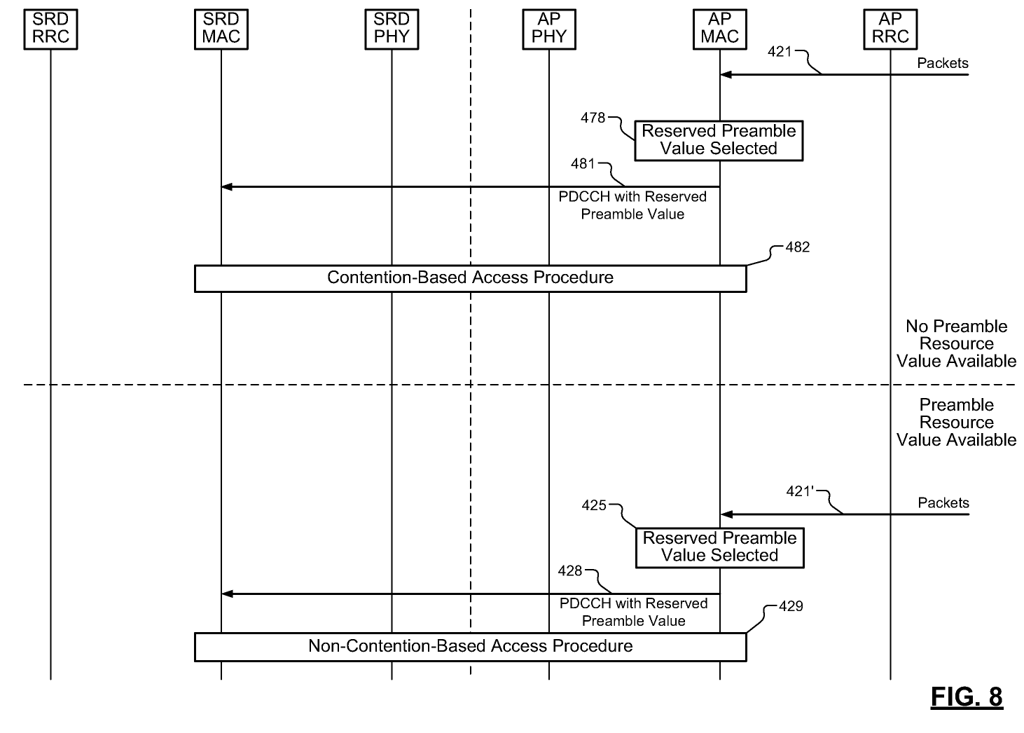

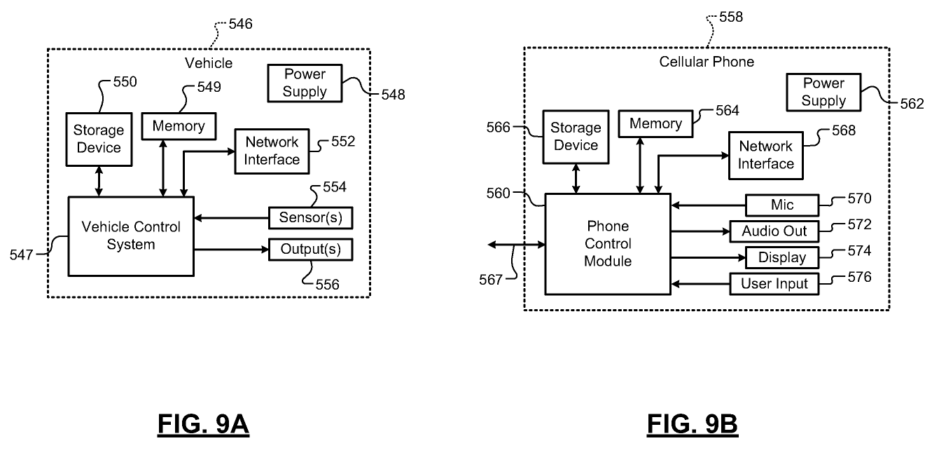

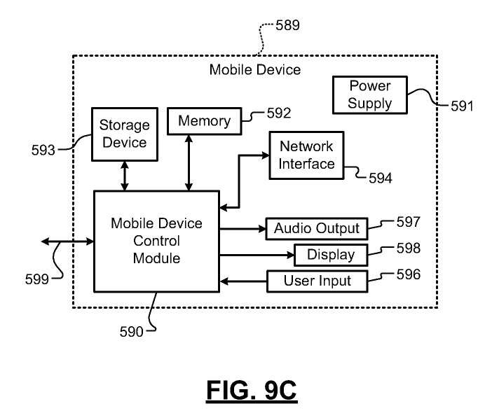

Referring now to FIGS. 9A-9C, various exemplary implementations incorporating the teachings of the present disclosure are shown.

Referring now to FIG. 9A, the teachings of the disclosure may be implemented in a network interface 552 of a vehicle 546. The vehicle 546 may include a vehicle control system 547, a power supply 548, memory 549, a storage device 550, and the network interface 552. If the network interface 552 includes a wireless local area network interface, an antenna (not shown) may be included. The vehicle control system 547 may be a powertrain control system, a body control system, an entertainment control system, an anti-lock braking system (ABS), a navigation system, a telematics system, a lane departure system, an adaptive cruise control system, etc.

The vehicle control system 547 may communicate with one or more sensors 554 and generate one or more output signals 556. The sensors 554 may include temperature sensors, acceleration sensors, pressure sensors, rotational sensors, airflow sensors, etc. The output signals 556 may control engine operating parameters, transmission operating parameters, suspension parameters, brake parameters, etc.

The power supply 548 provides power to the components of the vehicle 546. The vehicle control system 547 may store data in memory 549 and/or the storage device 550. Memory 549 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 550 may include an optical storage drive, such as a DVD drive, and/or a hard disk drive (HDD). The vehicle control system 547 may communicate externally using the network interface 552.

Referring now to FIG. 9B, the teachings of the disclosure can be implemented in a cellular network interface 567 of a cellular phone 558. The cellular phone 558 includes a phone control module 560, a power supply 562, memory 564, a storage device 566, and the cellular network interface 567. The cellular phone 558 may include a network interface 568, a microphone 570, an audio output 572, such as a speaker and/or output jack, a display 574, and a user input device 576, such as a keypad and/or pointing device. If the network interface 568 includes a wireless local area network interface, an antenna (not shown) may be included.

The phone control module 560 may receive input signals from the cellular network interface 567, the network interface 568, the microphone 570, and/or the user input device 576. The phone control module 560 may process signals, including encoding, decoding, filtering, and/or formatting, and generate output signals. The output signals may be communicated to one or more of memory 564, the storage device 566, the cellular network interface 567, the network interface 568, and the audio output 572.

Memory 564 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 566 may include an optical storage drive, such as a DVD drive, and/or a hard disk drive (HDD). The power supply 562 provides power to the components of the cellular phone 558.

Referring now to FIG. 9C, the teachings of the disclosure can be implemented in a network interface 594 of a mobile device 589. The mobile device 589 may include a mobile device control module 590, a power supply 591, memory 592, a storage device 593, the network interface 594, and an external interface 599. If the network interface 594 includes a wireless local area network interface, an antenna (not shown) may be included.

The mobile device control module 590 may receive input signals from the network interface 594 and/or the external interface 599. The external interface 599 may include USB, infrared, and/or Ethernet. The input signals may include compressed audio and/or video, and may be compliant with the MP3 format. Additionally, the mobile device control module 590 may receive input from a user input 596 such as a keypad, touchpad, or individual buttons. The mobile device control module 590 may process input signals, including encoding, decoding, filtering, and/or formatting, and generate output signals.

The mobile device control module 590 may output audio signals to an audio output 597 and video signals to a display 598. The audio output 597 may include a speaker and/or an output jack. The display 598 may present a graphical user interface, which may include menus, icons, etc. The power supply 591 provides power to the components of the mobile device 589. Memory 592 may include random access memory (RAM) and/or nonvolatile memory.

Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 593 may include an optical storage drive, such as a DVD drive, and/or a hard disk drive (HDD). The mobile device may include a personal digital assistant, a media player, a laptop computer, a gaming console, or other mobile computing device.

The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A service request device comprising:
a transceiver that receives a downlink signal that includes at least one of an unreserved value, a resource status value, and a reserved value from a base station, wherein the downlink signal is transmitted when a non-contention-based resource of the base station is not available for the service request device; and
a control module that initiates a contention-based access procedure that synchronizes the service request device with the base station based on the at least one of the unreserved value, the resource status value, and the reserved value,
wherein the transceiver receives packets from the base station in response to the service request device being synchronized with the base station.

2. The service request device of claim 1, wherein the non-contention-based resource comprises a reserved preamble value that is associated with one of N traffic channel resources corresponding to permitted transmission of data to the base station, where N is an integer.

3. The service request device of claim 1, wherein the transceiver receives a valid transmission period from the base station when receiving the reserved value,
wherein the valid transmission period is set to a predetermined value, and
wherein the control module initiates the contention-based access procedure based on the valid transmission period.

4. The service request device of claim 1, wherein the base station has X non-contention-based resources and Y contention-based resources, where X and Y are integers, and
wherein the X non-contention-based resources are reserved for network devices other than the service request device.

5. The service request device of claim 1, wherein the unreserved value is a contention-based preamble value, and
wherein the transceiver transmits a random preamble value associated with a contention-based access procedure based on the contention-based preamble value.

6. The service request device of claim 1, wherein the resource status value indicates availability of a reserved preamble value of the base station, and
wherein the transceiver transmits a random preamble value associated with a contention-based access procedure based on the resource status value.

7. The service request device of claim 6, wherein the transceiver receives a timing adjustment signal from the base station based on the random preamble value.

8. The service request device of claim 1, wherein the reserved value is dedicated to a network device other than the service request device.

9. The service request device of claim 1, wherein the base station receives the packets after time synchronization with the service request device is lost, and
wherein the transceiver receives the downlink signal from the base station to resynchronize the service request device with the base station.

10. The service request device of claim 1, wherein the transceiver transmits a random access channel signal to the base station during the contention-based access procedure based on the downlink signal.

11. A method of operating a service request device comprising:
receiving a downlink signal that includes at least one of an unreserved value, a resource status value, and a reserved value from a base station, wherein the downlink signal is transmitted when a non-contention-based resource of the base station is not available for the service request device;
initiating a contention-based access procedure that synchronizes the service request device with the base station based on the at least one of the unreserved value, the resource status value, and the reserved value; and
receiving packets from the base station in response to the service request device being synchronized with the base station.

12. The method of claim 11, wherein the non-contention-based resource comprises a reserved preamble value that is associated with one of N traffic channel resources corresponding to permitted transmission of data to the base station, where N is an integer.

13. The method of claim 11 further comprising:
receiving a valid transmission period from the base station when receiving the reserved value, wherein the valid transmission period is set to a predetermined value; and
initiating the contention-based access procedure based on the valid transmission period.

14. The method of claim 11, wherein the base station has X non-contention-based resources and Y contention-based resources, where X and Y are integers, and
wherein the X non-contention-based resources are reserved for network devices other than the service request device.

15. The method of claim 11 further comprising transmitting a random preamble value associated with a contention-based access procedure based on the contention-based preamble value, wherein the unreserved value is a contention-based preamble value.

16. The method of claim 11 further comprising transmitting a random preamble value associated with a contention-based access procedure based on the resource status value,
wherein the resource status value indicates availability of a reserved preamble value of the base station.

17. The method of claim 16 further comprising receiving a timing adjustment signal from the base station based on the random preamble value.

18. The method of claim 11, wherein the reserved value is dedicated to a network device other than the service request device.

19. The method of claim 11 further comprising receiving the downlink signal from the base station to resynchronize the service request device with the base station,
wherein the base station receives the packets after time synchronization with the service request device is lost.

20. The method of claim 11 further comprising transmitting a random access channel signal to the base station during the contention-based access procedure based on the downlink signal.
